(19) United States
(12) Patent Application Publication
(10) Pub. No.: US 2011/0043666 A1
(43) Pub. Date: Feb. 24, 2011

(54) IMAGE PROCESSING APPARATUS, IMAGE PROCESSING METHOD, AND COMPUTER PROGRAM STORAGE MEDIUM

(75) Inventor: Shinichi Mitsumoto, Saitama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/852,277

(22) Filed: Aug. 6, 2010

(30) Foreign Application Priority Data
Aug. 19, 2009 (JP) 2009-190442

(51) Int. Cl. H04N 5/217; G06K 9/40

(52) U.S. Cl. 348/241; 382/255; 348/E05.078

(57) ABSTRACT

An image processing apparatus includes an input unit configured to input image data representing a captured image photographed by a photographing unit, a region specifying unit configured to specify a region of an in-focus object in the captured image, a filter acquisition unit configured to acquire a correction filter for correcting blur in the captured image according to information about a distance to the in-focus object, and a correction unit configured (a) to perform blur correction processing on the captured image by applying the correction filter to the region specified by the region specifying unit, and (b) not to perform the blur correction processing performed on the region specified by the region specifying unit on a region other than the region specified by the region specifying unit.

### BACKGROUND OF THE INVENTION

1. Field of the Invention

The present invention relates to an image processing apparatus, an image processing method, and a computer program storage medium, and in particular, to an image processing apparatus, an image processing method, and a computer program storage medium suitable for correcting deterioration of image quality caused by an imaging optical system.

2. Description of the Related Art

Image quality of a captured image is influenced by an imaging optical system. For example, when a high-performance lens is used, a less-blurred, clear image can be acquired. On the other hand, when an inexpensive, low-performance lens is used, a blurred image is acquired.

As a method for correcting the blur of the image caused by the imaging optical system, a conventional method has been known for correcting the blur of the image caused by the imaging optical system by performing image processing on the captured image. According to this method, characteristics of the blur of the image caused by the imaging optical system are computerized in advance to correct the blur of the image based on the characteristics data thereof.

As a method for computerizing the characteristics of the blur of the image caused by the imaging optical system, a method is known for expressing the characteristics of the blur in a point spread function (PSF). The PSF expresses how one point of an object is blurred. For example, two-dimensional spread of light on a surface of a sensor when a light-emitting member having a very small volume is photographed in darkness is equivalent to the PSF of the imaging optical system that photographs the image.

An ideal imaging optical system causing less blur has the PSF substantially expressed at one point. An imaging optical system causing more blur has the PSF having a certain spread not expressed at one point. When the PSF of the imaging optical system is actually acquired as the data, an object such as a point light source does not need to be photographed. For example, a method is known for acquiring the PSF from the captured image, which is acquired by photographing a chart having an edge in black and white, using a calculation method corresponding to the chart. Further, the PSF can be also acquired by calculating design data of the imaging optical system.

As a method for correcting the blur using PSF data, a method using an inverse filter is widely known. A case where the point light source is photographed in darkness will be described. In the imaging optical system causing blur, on the surface of the sensor, the light emitted from the point light source forms a light distribution having a certain spread.

An imaging element samples light to generate electric signals. When the electric signals are processed into an image, a digital image of the photographed light emitting source can be acquired. In the imaging optical system causing blur, one pixel of the point light source in the captured image has a pixel value that is not “0”, and some surrounding pixels of the pixel also have pixel values that are not “0”.

Image processing for converting into the image on which the substantial one point has the pixel value that is not “0” is referred to the inverse filter. Using the inverse filter, the image to be acquired by photographing with the imaging optical system causing less blur can be acquired. The point light source is described above as an example. Further, when the light from the object is considered as gathering of the point light sources, since each light emitted from each part of the object is not blurred, the less blurred image can be acquired even from a general object.

Next, a specific method for constructing the inverse filter will be described using mathematical equations. A captured image photographed by the ideal imaging optical system causing no blur is defined as f(x, y). (x, y) indicates a two-dimensional position, and f(x, y) indicates a pixel value at position (x, y). Meanwhile, a captured image photographed by the imaging optical system causing blur is defined as g(x, y). The PSF of the imaging optical system causing blur is defined as h(x, y). A relationship among “f”, “g”, and “h” satisfies the following equation (1).

g(x, y)=h(x, y)*f(x, y) (1)

In equation (1), reference symbol “*” refers to convolution. Correcting the blur can be also described to estimate the pixel value “f” of the captured image acquired by the imaging optical system causing no blur from the image “g” photographed by the imaging optical system causing blur and the PSF “h” of the imaging optical system. Further, when Fourier transform is performed on the pixel value “f” to convert into a display format for a spatial frequency plane, a multiplication format for each frequency is acquired as described by the following equation (2).

G(u, v)=H(u, v)·F(u, v) (2)

An optical transfer function (OTF) “H” is acquired by performing the Fourier transform on the PSF. Coordinates “u” and “v” on a two-dimensional frequency plane indicate frequencies. “G” is acquired by performing the Fourier transform on the captured image “g” photographed by the imaging optical system causing blur, and “F” is acquired by performing the Fourier transform on “f”. To generate an image having no blur from a photographed image having the blur, both sides of equation (2) maybe divided by “H” as described by the following equation (3).

G(u, v)/H(u, v)=F(u, v) (3)

The inverse Fourier transform is performed on F(u, v) to return “F” to an actual plane, and then the image f(x, y) having no blur can be acquired as a recovered image.

The inverse Fourier transform is performed on “H-1”, and acquired values are defined as “R”. The image f(x, y) having no blur can be acquired by performing convolution on the image on the actual plane as described by the following equation (4).

g(x, y)*R(x, y)=f(x, y) (4)

This R(x, y) is referred to as the inverse filter. Actually, since a division by “0” is performed at a frequency (u, v) where H(u, v) is “0”, the inverse filter R(x, y) may be slightly modified.

Normally, the higher the frequency is, the smaller a value of the OTF becomes. Accordingly, the higher the frequency is, the larger the inverse filter R(x, y), which is an inverse number of the OTF, becomes. Therefore, if convolution processing is performed on the captured image “g” having blur using the inverse filter, high frequency components of the captured image are enhanced. However, since the actual image includes noise, which has generally a high frequency, the inverse filter enhances the noise.

Thus, a method is known for modifying the equation of the inverse filter R(x, y) and then giving characteristics for not enhancing the high frequency to the inverse filter R(x, y). A Wiener filter is widely known for not greatly enhancing the high frequency, considering the noise.

As described above, since there are differences between ideal conditions and actual cases where the noise is generated in the captured image or the frequency having the OTF “0” is generated, the blur cannot be completely eliminated. However, processing described above can decrease the blur of the image. Hereinafter, all filters, such as the inverse filter and the Wiener filter, used for correcting the blur are referred to as recovery filters. The recovery filters are characterized by using the PSF of the imaging optical system for calculation.

Even in a focusing state suitable for the object (in-focus state), the image may be deteriorated due to aberration of lenses. The most suitable recovery filter varies depending on a position in an image plane and a distance from an imaging lens to the object. If the recovery filter is uniformly applied all over the image, in a region where a recovery characteristic is not adjusted due to the distance and the position that are not adjusted, a false color may be generated.

Japanese Patent Application Laid-Open No. 2008-67093 discusses a technique in which image processing is performed on each part of the image in image data according to the distance to the object. However, the technique discussed in Japanese Patent Application Laid-Open No. 2008-67093 does not consider image recovery processing for addressing deterioration of the image caused by the aberration of lenses.

### SUMMARY OF THE INVENTION

The present invention is directed to an image processing apparatus that is capable of adequately reducing blur of an image caused by an imaging optical system.

According to an aspect of the present invention, an image processing apparatus includes an input unit configured to input image data representing a captured image photographed by a photographing unit, a region specifying unit configured to specify a region of an in-focus object in the captured image, a filter acquisition unit configured to acquire a correction filter for correcting blur in the captured image according to information about a distance to the in-focus object, and a correction unit configured (a) to perform blur correction processing on the captured image by applying the correction filter to the region specified by the region specifying unit, and (b) not to perform the blur correction processing performed on the region specified by the region specifying unit on a region other than the region specified by the region specifying unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a basic configuration of an imaging apparatus.

FIG. 2 is a flowchart illustrating processing performed by an image processing unit.

FIG. 3 illustrates a configuration of the imaging apparatus.

FIGS. 4A and 4B illustrate shapes of openings of diaphragms.

FIG. 5 illustrates a first example of a power spectrum.

FIG. 6 illustrates a second example of a power spectrum.

FIG. 7 is a flowchart illustrating processing for acquiring a distance image.

FIGS. 8A and 8B illustrate an original image and a distance image, respectively.

FIG. 9 is a flowchart illustrating blur correction processing.

### DESCRIPTION OF THE EMBODIMENTS

Various exemplary embodiments, features, and aspects of the invention will be described in detail below with reference to the drawings.

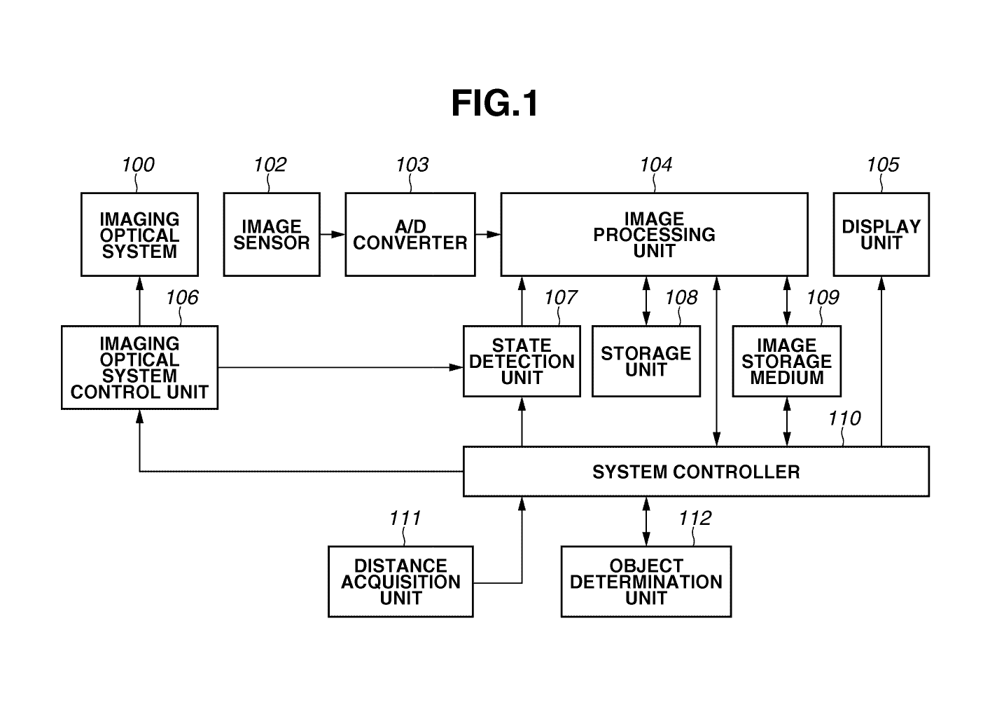

FIG. 1 is an example illustrating a basic configuration of an imaging apparatus. An imaging optical system 100 (optical lens system) forms an image with light from an object (not illustrated) on an image sensor 102. The image-formed light is converted by the image sensor 102 into electric signals, which are further converted into digital signals by an analog/digital (A/D) converter 103, and then input into an image processing unit 104. The image sensor 102 is a photoelectric conversion element for converting light signals of the image formed on a light-receiving surface into the electric signals for each light-receiving element located at a position corresponding to the light-receiving surface.

A system controller 110 includes a central processing unit (CPU), a read only memory (ROM), and a random access memory (RAM) and executes a computer program stored in the ROM to control the imaging apparatus. The image processing unit 104 acquires imaging state information about the imaging apparatus from a state detection unit 107. The state detection unit 107 may acquire the imaging state information about the imaging apparatus from the system controller 110, or may acquire the imaging state information thereabout from devices other than the system controller 110.

For example, the state detection unit 107 can acquire the imaging state information about the imaging optical system 100 from an imaging optical system control unit 106. A distance acquisition unit 111 acquires distance information about a photographed image (information about an object distance from the imaging lens to the object). The image processing unit 104 performs region segmentation according to the object distance based on the distance information acquired by the distance acquisition unit 111.

An object determination unit 112 acquires a focused region (in-focus region) of the captured image based on the distance information indicating a lens position detected by the state detection unit 107 and the distance image described below. Then, the object determination unit 112 extracts a main object region from the focused region.

The image processing unit 104 acquires the distance information acquired by the distance acquisition unit 111, information about a main object region extracted by the object determination unit 112, and a correction coefficient necessary for generating the most suitable recovery filter from a storage unit 108. More specifically, according to the present exemplary invention, the storage unit 108 includes a database in which the correction coefficient necessary for generating the recovery filter is registered for each distance information. The image processing unit 104 reads the correction coefficient corresponding to the distance information about the main object region from the database.

The image processing unit 104 performs blur correction processing (aberration correction processing of the imaging optical system 100) on the image data (main object region) input into the image processing unit 104 using the recovery filter based on the correction coefficient. The image data on which the blur (deterioration) caused by the imaging optical system 100 is corrected by the image processing unit 104 is stored in the image storage medium 109 or displayed by a display unit 105.

The recovery filter to be used for image recovery processing is generated using design data of the imaging optical system 100 as described in “Description of the Related Art”. The recovery filter may be generated using intersection data as well as the design data.

Further, for the region other than the main object region, correction processing (region other than main object region correction processing), which is different from the blur correction processing (main object region correction processing) performed on the main object region, is performed. As an example of correction processing for the region other than main object region, (1) the correction processing is not performed, or (2) the recovery processing having a recovery level lower than that for the main object region correction processing may be performed.

When the processing (2) is performed, not to generate a false outline by the main object region correction processing and the region other than the main object region collection processing, the recovery level is adjusted so that a level of the correction processing is continuous at a boundary of the main object.

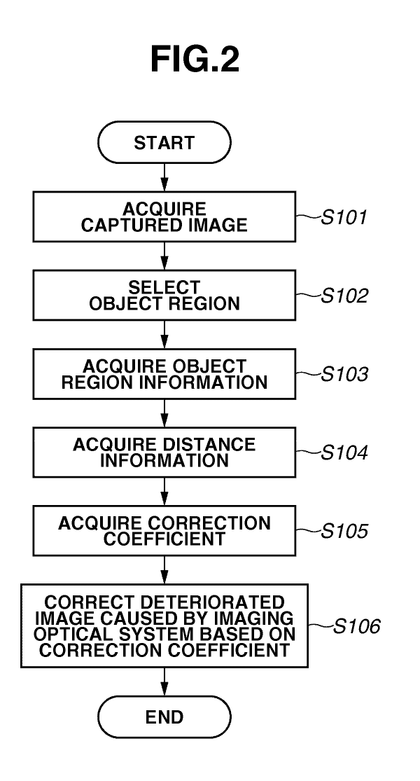

FIG. 2 is a flowchart illustrating an example of processing performed by the image processing unit 104. In step S101, the image processing unit 104 acquires data of the captured image. In step S102, the object determination unit 112 selects the main object region from the region where the captured image data is in an in-focus state.

In step S103, the image processing unit 104 acquires information about the main object region.

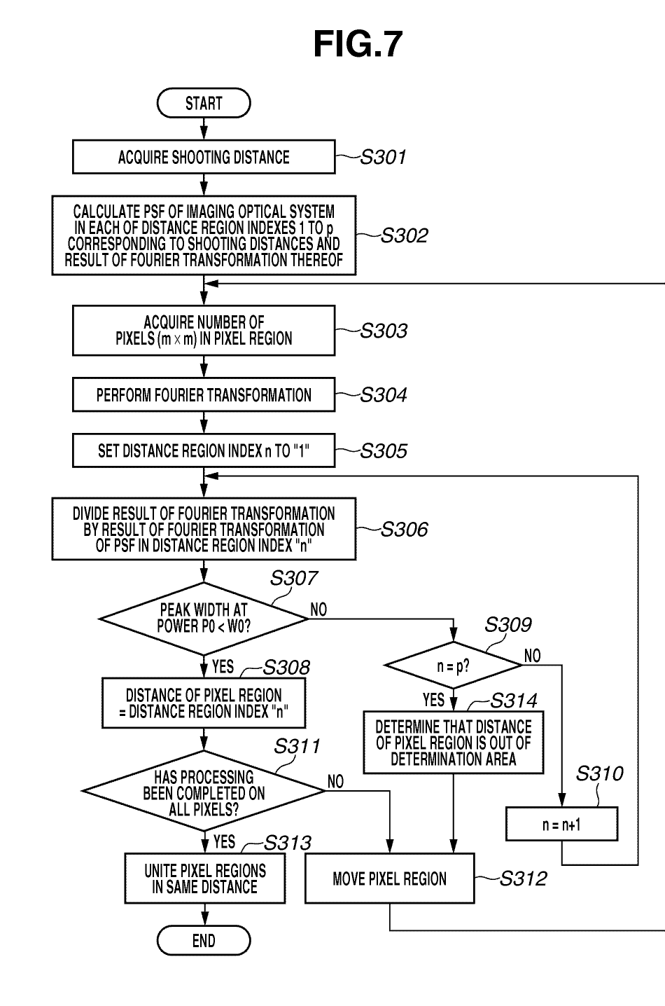

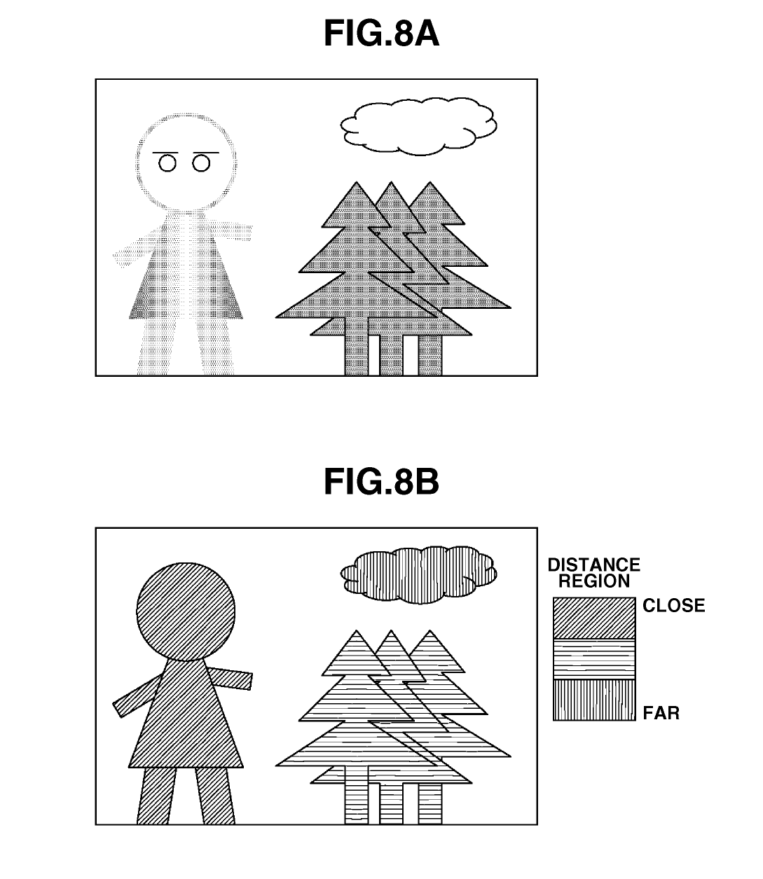

In step S104, the image processing unit 104 acquires the distance information about the main object region. According to the present exemplary embodiment, the distance information is a distance image described below (refer to FIGS. 7, 8A, and 8B).

In step S105, the image processing unit 104 acquires a correction coefficient corresponding to the distance information about the main object region from the storage unit 108. At this point, pre-processing prior to blur correction may be performed on the image data as necessary. For example, processing for compensating for defects of the image sensor 102 may be performed prior to the blur correction.

In step S106, the image processing unit 104 corrects the blur (deterioration) caused by the imaging optical system 100 on a specific image component of the captured image using the recovery filter to which the acquired correction coefficient is applied. According to the present exemplary embodiment, the specific image component of the captured image is, for example, an image component in a region where the blur of the main object region is generated.

According to the present exemplary embodiment, a lens unit, which is the imaging optical system 100, is interchangeable. Since characteristics of the PSF vary depending on the lens, the recovery filter is changed according to the imaging optical system 100 mounted on the imaging apparatus. Therefore, for example, the system controller 110 stores the recovery filter for each PSF, so that the recovery filter of the PSF corresponding to the mounted imaging optical system 100 can be acquired.

The object determination unit 112 performs determination and extraction of the main object region on an in-focus region. Information used for determination includes, for example, position information about the focused image, information about a face detection function and a human detection function which the imaging apparatus has as a camera function, and information acquired by image processing such as face detection, human detection, and skin color detection that can be acquired from the image. Further, a user may set the main object region in advance by operating a user interface during photographing.

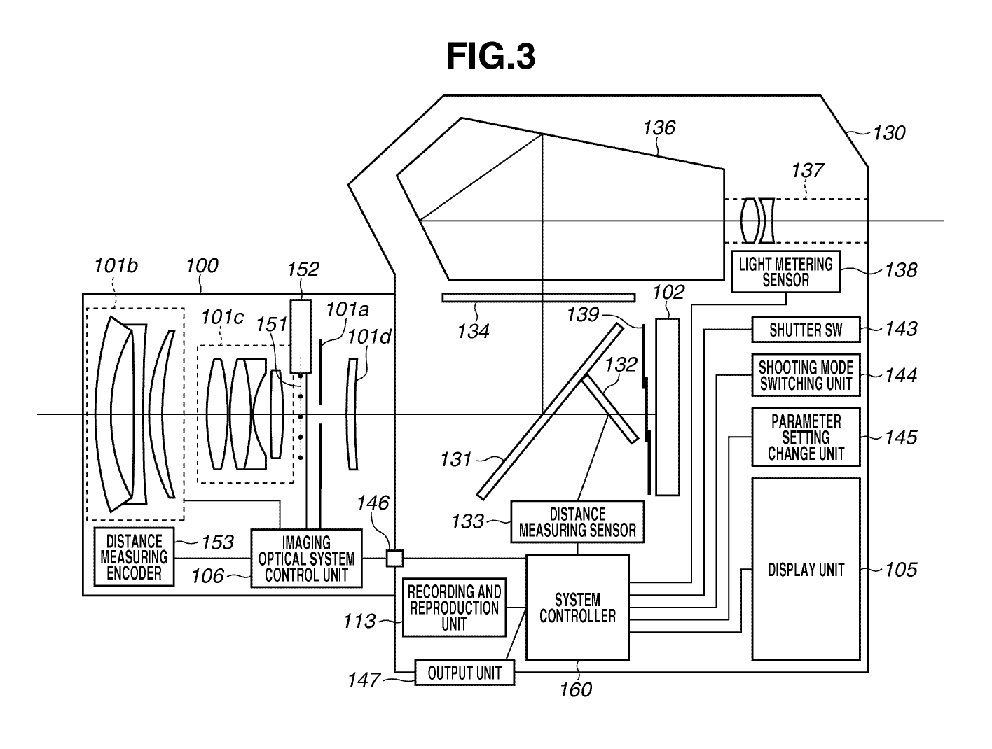

FIG. 3 illustrates an example of a configuration of the imaging apparatus. FIG. 3 illustrates a case where a digital single-lens reflex camera is used as the imaging apparatus as an example. This configuration is not limited to the digital single-lens reflex cameras but can be applied to imaging apparatuses, such as compact digital cameras and digital video cameras.

In FIG. 3, the imaging apparatus includes a camera body 130 and the imaging optical system 100 (interchangeable lens unit).

The imaging optical system 100 includes lens elements 101b, 101c, and 101d. A focusing lens group 101b adjusts an in-focus position of a photographing image plane by moving back and forth along an optical axis. A variator lens group 101c changes the focal length of the imaging optical system 100 by moving back and forth along the optical axis to perform zooming on the photographing image plane. A fixed lens 101d improves lens performances such as telecentricity. The imaging optical system 100 further includes a diaphragm 101a.

A distance measuring encoder 153 reads the position of the focusing lens group 101b, and generates signals corresponding to position information about the focusing lens group 101b, which is the object distance. The imaging optical system control unit 106 changes an opening diameter of the diaphragm 101a based on the signals transmitted from the camera body 130, and performs movement control on the focusing lens group 101b based on the signals transmitted from the distance measuring encoder 153.

In addition, the imaging optical system control unit 106 transmits to the camera body 130 lens information including the object distance based on the signals generated by the distance measuring encoder 153, the focal length based on position information about the variator lens group 101c, and lens information including an F-number based on the opening diameter of the diaphragm 101a. A mount contact point group 146 serves as a communication interface between the imaging optical system 100 and the camera body 130.

Next, an example of the configuration of the camera body 130 will be described. A main mirror 131 is slanted in a photographing light path in a state for observing a finder, and cam be retracted outside the photographing light path in a state for photographing. The main mirror 131 is a half mirror and, when being slanted in the photographing light path, about half of the light from the object to a distance measuring sensor 133 described below is transmitted through the main mirror 131.

A finder screen 134 is disposed on a surface on which the image is to be formed through the lenses 101b, 101c, and 101d. A photographer checks the photographing image plane by observing the finder screen 134 through an eyepiece 137. A pentagonal prism 136 changes the light path for leading the light from the finder screen 134 to the eyepiece 137.

The distance measuring sensor 133 receives a light flux from the imaging optical system 100 through a sub mirror 132 provided at the rear side of the main mirror 131, which can be retracted. The distance measuring sensor 133 transmits a state of the received light flux to the system controller 110. The system controller 110 determines the in-focus state of the imaging optical system 100 with respect to the object based on the states of the light flux.

The system controller 110 calculates operation directions and operation amounts of the focusing lens group 101b based on the determined in-focus state and the position information about the focusing lens group 101b transmitted from the imaging optical system control unit 106.

A light metering sensor 138 generates luminance signals in a predetermined region on an image plane formed on the finder screen 134, and transmits the luminance signals to the system controller 110. The system controller 110 determines an appropriate exposure amount for the image sensor 102 based on values of the luminance signals transmitted from the light metering sensor 138. Further, the system controller 110 performs control on the diaphragm 101a according to a shutter speed set for providing the appropriate exposure amount according to a shooting mode selected by a shooting mode switching unit 144.

Furthermore, the system controller 110 performs shutter speed control on a shutter 139 according to a set aperture value or information about a diaphragm plate 151 transmitted with the lens information. Moreover, the system controller 110 can perform a combination of the control operations described above, as necessary.

In a shutter speed priority mode, the system controller 110 calculates the opening diameter of the diaphragm 101a for acquiring the appropriate exposure amount associated with the shutter speed set by the parameter setting change unit 145. The system controller 110 adjusts the opening diameter of the diaphragm 101a by transmitting instructions to the imaging optical system control unit 106 based on the calculated value described above.

On the other hand, in an aperture priority mode or a diaphragm plate using shooting mode, the system controller 110 calculates a shutter speed for acquiring the appropriate exposure amount associated with a set aperture value or a selected state of the diaphragm plate 151. When the diaphragm plate 151 is selected, the imaging optical system control unit 106 gives to the camera body 130 information about an aperture shape and parameters regarding the exposure when the above-described communication is performed.

Further, in a program mode, the system controller 110 determines the shutter speed and the aperture value according to a combination of the predetermined shutter speed for the appropriate exposure amount and the aperture value or a usage of the diaphragm plate 151.

The processing described above is started by half pressing of a shutter switch (SW) 143. At this point, the imaging optical system control unit 106 drives the focusing lens group 101b until the position information indicated by the distance measuring encoder 153 matches a target operation amount according to the operation direction and the operation amount of the focusing lens group 101b determined by the system controller 110.

Next, a photographing sequence is started by full pressing of the shutter SW 143. Upon start of the photographing sequence, first, the main mirror 131 and the sub mirror 132 are folded and retracted outside the photographing light path.

Then, according to the calculated value by the system controller 110, the imaging optical system control unit 106 narrows down the diaphragm 101a or a diaphragm plate driving device 152 places the diaphragm plate 151 inside the light path. The shutter 139 is opened and closed according to the shutter speed calculated by the system controller 110. After this operation, the diaphragm 101a is opened or the diaphragm plate 151 is retracted. The main mirror 131 and the sub mirror 132 are then returned to their original positions.

The image sensor 102 transfers the luminance signal of each pixel stored while the shutter 139 is opened. The system controller 110 maps the luminance signals into an appropriate color space to generate a file in an appropriate format. The display unit 105 mounted at the rear side of the camera body 130 displays a setup state based on setup operations of the shooting mode switching unit 144 and a parameter setting change unit 145. Further, after photographing, the display unit 105 displays a thumbnail image generated by the system controller 110.

The camera body 130 further includes a recording and reproduction unit 113 for a detachable memory card. After photographing, the recording and reproduction unit 113 records a file generated by the system controller 110 on the memory card. Further, the generated file can be output to an external computer via an output unit 147 and a cable.

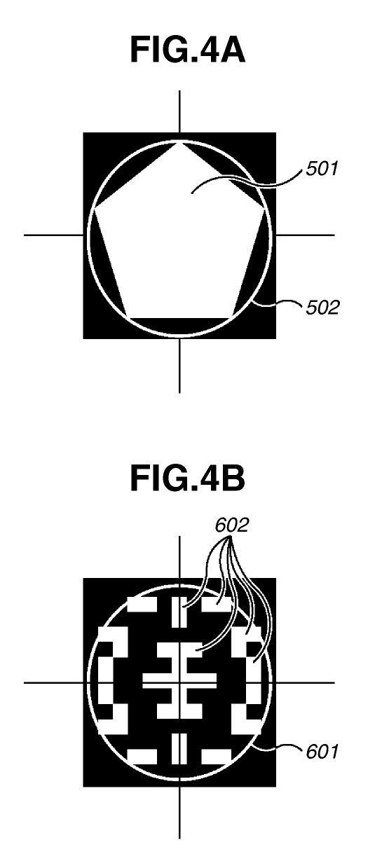

FIGS. 4A and 4B illustrate an example of an opening shape of the normal diaphragm 101a and an example of the opening shape of the diaphragm plate 151, which forms a special diaphragm, respectively.

In FIG. 4A, according to the present exemplary embodiment, since the diaphragm 101a forms an iris diaphragm including five diaphragm blades, the opening thereof has a round pentagonal shape. A shape 501 of the aperture illustrates a full aperture. A circle 502 (full opening diameter) gives the full aperture when the aperture is opened in a circle shape.

In FIG. 4B, the diaphragm plate 151 has a shape having a number of apertures for a purpose described below. A circle 601 (full opening diameter) gives the full aperture when the aperture is opened in the circle shape. Since each opening 602 of deformed aperture is located symmetrically with respect to the optical axis vertical to a paper surface, in FIG. 4B, only apertures in a primary quadrant defined by two orthogonal axis given on an aperture surface having the optical axis illustrated in FIG. 4B as an original point are indicated with reference numeral 602.

As illustrated in FIG. 4B, since the diaphragm plate 151 transmits only apart of the light flux passing through the full aperture, an amount of light transmitted through the lens is decreased. A value of F-number that represents the ratio of aperture diameters for giving the amount of the transmitted light equivalent to that after being decreased as described above is referred to as T-number. The T-number is an index indicating true brightness of the lens, which cannot be expressed by only the ratio of the opening diameter (F-number). Therefore, when the diaphragm plate 151 is used, the imaging optical system control unit 106 transmits information about the T-number as information about the brightness of the lens to the camera body 130.

Further, in FIG. 4B, for example, the circle 601 is expressed as binary image information including 13×13 pixels, in which the opening portion is defined as “1” and a light-blocking portion is defined as “0”. Further, a physical size of each pixel can be expressed by information about a ratio to the full-open aperture 601. A size itself of each pixel may be expressed as the physical size thereof.

The imaging optical system 100 having the aperture opening as illustrated in FIG. 4B includes a great number of apertures. Therefore, a power spectrum acquired by performing the Fourier transform on the PSF becomes “0” in some spatial frequencies. Further, values of the spatial frequencies that give “0” described above vary according to the object distances. (Refer to Coded Aperture method, “Image and Depth from a Conventional Camera with a Coded Aperture, Levin et al., ACM Transactions on Graphics, Vol. 26, No. 3, Article 70, Publication date: July 2007”) By using this phenomenon, the distance image of the object can be acquired.

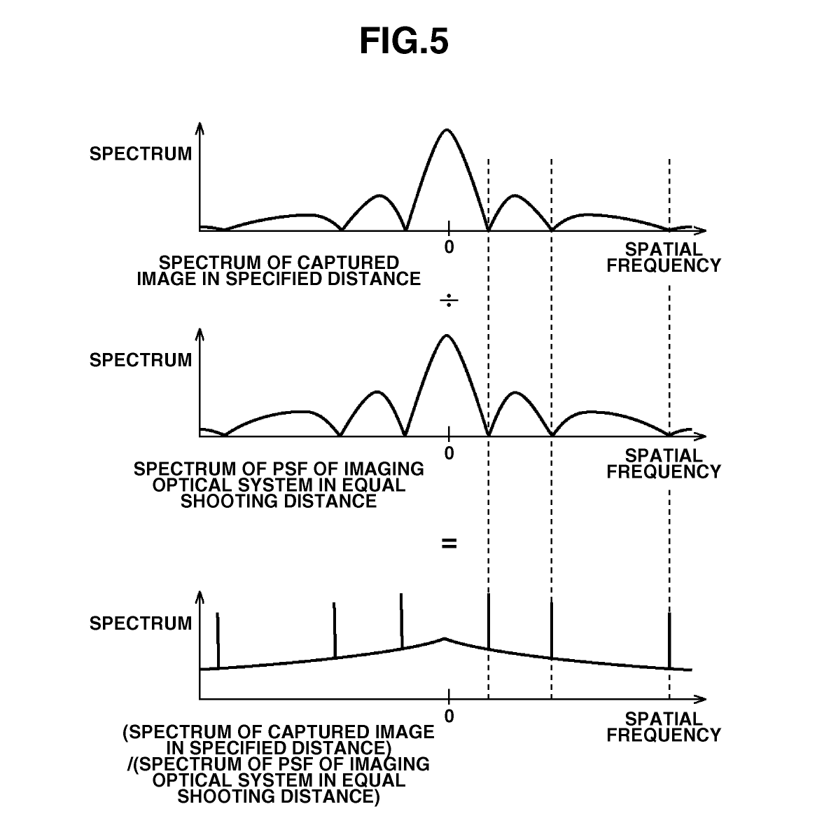

FIG. 5 schematically illustrates an example of a process in which the power spectrum in a specified shooting distance is divided by the power spectrum of the PSF of the imaging optical system 100 in the shooting distance equal to the above-described shooting distance.

The top portion of FIG. 5 illustrates an example of the power spectrum of the captured image in a certain specified shooting distance. The middle portion of FIG. 5 illustrates an example of the power spectrum that can be acquired from the PSF of the imaging optical system 100 of the object in the shooting distance equal to that of the power spectrum illustrated in the top portion of FIG. 5. Since these power spectrums are generated by the same shape of the aperture opening, the spatial frequencies match each other at the power spectrum “0”.

Accordingly, as illustrated in the bottom portion of FIG. 5, the power spectrum acquired by dividing the power spectrum in the top portion of FIG. 5 by the power spectrum of the middle portion of FIG. 5 has a spike shape at an optical system power spectrum “0” in the special frequency. However, a width of the spike shape is extremely small,

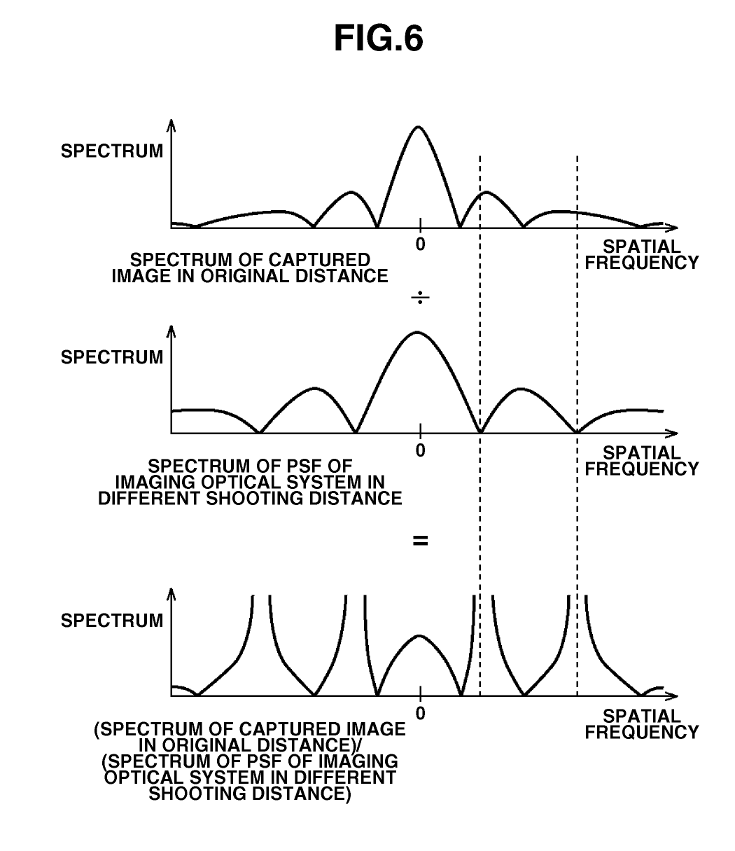

FIG. 6 schematically illustrates an example of a process in which the power spectrum in a specific shooting distance is divided by the power spectrum of the PSF of the imaging optical system 100 in a shooting distance different from the specified shooting distance.

The top portion of FIG. 6 illustrates the power spectrum of the captured image equal to that of the top portion of FIG. 5. The middle portion of FIG. 6 illustrates an example of the power spectrum that can be acquired from the PSF of the imaging optical system 100 in a shooting distance different from that of the power spectrum illustrated in the top portion of FIG. 6. Since the spatial frequency that gives “0” to the PSF of the imaging optical system 100 varies according to the object distance, the spatial frequencies that give “0” to the two power spectrums do not match each other.

Therefore, as illustrated in the bottom portion of FIG. 6, the power spectrum acquired by dividing the power spectrum in the top portion of FIG. 6 by the power spectrum in the middle portion thereof has a peak having a large width centering on the spatial frequency at the optical system power spectrum “0”.

By comparing FIG. 5 with FIG. 6, the following descriptions can be given. Photographing is performed using the diaphragm illustrated in FIG. 4B. The power spectrum of a certain part of the image is divided by the power spectrum (known) of the optical system corresponding to a specific object distance. When the distances of the two power spectrums are not equal to each other, the power spectrum acquired as a quotient has a peak having a large width. On the other hand, when the distances of the two power spectrums are equal to each other, the power spectrum acquired as a quotient does not have a peak having a width.

Therefore, power spectrums of the optical system corresponding to a number of object distance regions to be divided are prepared in advance. Each of the power spectrums are divided by the power spectrum of each part of the captured image. At this point, an object region where the quotient of the division has only a peak having a width smaller than a predetermined width indicates the object distance of that part of the captured image.

By performing the above-described processing, the region of the image is divided according to the object distance of each part of the captured image to acquire the distance image. The processing may be performed by the system controller 110. Alternatively, an image file recorded on the memory card or directly output to a personal computer (PC) may be processed by the PC.

Next, with reference to a flowchart illustrated in FIG. 7, an example in which information about the object distance is acquired and then the distance image is acquired will be described. A case where the system controller 110 performs the processing will be described as an example.

In step S301, the system controller 110 acquires distance information (shooting distance) about the lens from the position information about the focusing lens group 101b after focusing. In step S302, based on the distance information about the lens, the system controller 110 calculates each PSF of the imaging optical system 100 and the power spectrum of the PSF (result of Fourier transformation) when the object distance is divided into “p” (integer two or more) steps.

For the calculation, aperture shape information and lens information may be used. Alternatively, the computerized PSF of the imaging optical system 100 in advance and the power spectrum thereof may be combined with the aperture shape information to perform the calculation.

In step S303, the system controller 110 extracts a specific small region of the image (e.g., a region size that can cover a maximum amount of blur in the distance region to be generated). Next, in step S304, the system controller 110 performs Fourier transformation on the small region to acquire the power spectrum. In step S305, the system controller 110 sets a value of a distance region index “n” to “1” to start the distance region to be compared with the power spectrum from a first distance region.

In step S306, the system controller 110 divides the power spectrum in the small region of the image acquired in step S304 by the optical system power spectrum of the distance region index “n” acquired in step S302.

In step S307, regarding the power spectrum acquired in step S306, the system controller 110 compares a width of a part giving the power spectrum value P0 exceeding “1” with a predetermined value W0 to determine whether the width of the part is less than the predetermined value W0.

As a result of the determination, regarding the power spectrum acquired in step S306, when the width of the part giving the power spectrum value P0 exceeding “1” is less than the predetermined value W0 (YES in step S307), the object distance of the small region of the target image corresponds to the object distance associated with the distance region index “n” in a state described above. The processing then proceeds to step S308, in which the system controller 110 assigns the distance region index “n” to the corresponding region.

On the other hand, regarding the power spectrum acquired instep S306, when the width giving the power spectrum value P0 exceeding “1” is the predetermined value W0 or more (NO in step S307), the object distance of the small region of the target image does not correspond to the object distance associated with the distance region index “n”. The processing then proceeds to step S309.

In step S309, the system controller 110 determines whether the processing is completed on all object distance regions. More specifically, the system controller 110 determines whether the distance region index “n” is equal to “p”.

When the distance region index “n” is equal to “p” (YES in step S309), the processing proceeds to step S314, in which the system controller 110 determines that the small region of the target image does not include the corresponding object distance region. The processing then proceeds to step S312. In step S312, the system controller 110 moves the small region (pixel region) of the target image to, for example, an image small region adjacent to the current region. The processing then returns to step S303.

On the other hand, when the distance region index “n” is not equal to “p” (NO in step S309), the processing proceeds to step S310, in which the system controller 110 adds “1” to the distance region index “n”. The processing then returns to step S306.

In step S308, when the distance region index “n” is assigned to the small region of the target image, the processing proceeds to step S311. In step S311, the system controller 110 determines whether the processing is completed on all pixels. When the processing is not completed on all the pixels (NO in step S311), the processing proceeds to step S312, in which the system controller 110 moves the small region (pixel region) of the target image to, for example, the image small region adjacent to the current region.

On the other hand, when the processing is completed on all the pixels (YES in step S311), the processing proceeds to step S313, in which the system controller 110 unites the pixel regions in the same object distance to complete the distance image. Subsequently, the processing performed with the flowchart illustrated in FIG. 7 ends. FIG. 8A illustrates an original image, and FIG. 8B illustrates an example of the distance image acquired by performing the processing described above.

A method for acquiring the object distance is not limited to the methods described in the present exemplary embodiment. For example, the method is known for acquiring the object distance by performing image processing on the captured image using a parallax image. Further, a distance measuring apparatus may be built in the imaging apparatus or connected to an outside thereof to acquire the object distance using the distance measuring apparatus. Furthermore, the distance information may be manually acquired.

Next, an example of the blur correction processing will be described in detail. According to the present exemplary embodiment, as described in “Description of the Related Art”, the blur correction is performed using the recovery filter for each channel acquired by a lens sensor. For this blur correction, the filter needs to be generated for each channel so that filter processing can be performed. According to the present exemplary embodiment, an amount of calculation can be further decreased by converting the chromaticity components of multi-channel into a luminance component.

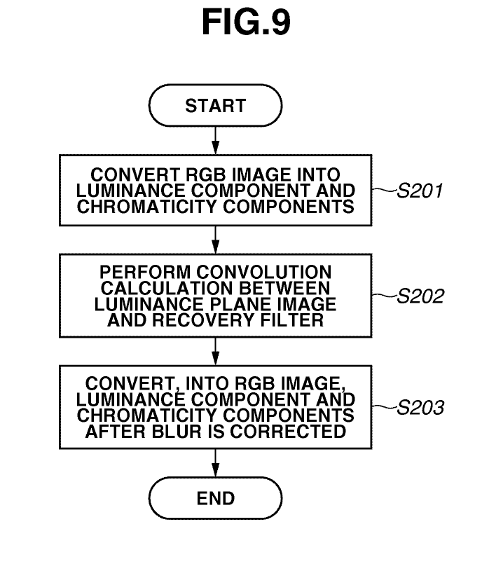

With reference to a flowchart illustrated in FIG. 9, an example of the blur correction processing will be described. An example in which the system controller 110 performs processing will be described in the following descriptions. In step S201, the system controller 110 converts a red-green-black (RGB) image, which is the captured image, into the chromaticity components and the luminance component. For example, when the captured image includes three planes of RGB, each pixel in the image is divided into the luminance component “Y” and the chromaticity components Ca and Cb by the following equations (5), (6), and (7).

Y=Wr·R+Wg·G+Wb·B (5)

Ca=R/G (6)

Cb=B/G (7)

Wr, Wg, and Wb are weighting coefficients for converting each pixel value of RGB into the luminance component “Y”.

As the simplest weighting, Wr=Wg=Wb=1/3 can be considered. Further, the chromaticity components Ca and Cb represent the ratio of “R” to “G” and the ratio of “B” to “G”. An example described here is just one of examples, and it is important to divide each pixel value into the signals representing the luminance and the signals representing the chromaticity.

Thus, the image may be converted into various types of proposed color spaces, such as Lab or Yuv, and divided into the luminance component and the chromaticity components. For simple descriptions, a case where the luminance component “Y” and the chromaticity components Ca and Cb expressed in the above-described equations (5), (6), and (7) are used will be described as an example.

In step S202, the system controller 110 applies the recovery filter to the image on the luminance plane. A method for constructing the recovery filter will be described below.

In step S203, the system controller 110 converts the luminance plane representing the luminance after the blur has been corrected and the Ca and Cb planes representing the chromaticity into the RGB image again.

According to the present exemplary embodiment, the blur correction is performed on the luminance plane. If the PSF corresponding to each color on the RGB plane is calculated based on a lens design value, the PSF of the luminance plane is expressed by the following equation (8).

PSFy=Wr·PSFr+Wg·PSFg+Wb·PSFb (8)

In other words, the PSF of the luminance plane is acquired by combining the PSF with the above described weighting coefficient. Based on this PSF, the recovery filter described above is constructed with the PSF of the luminance. As described above, since the PSF varies depending on the lens, the recovery filter can vary depending on the lens.

As described above, according to the present exemplary embodiment, the object distance, which is the distance between the imaging lens and the object, is acquired, the image region is divided according to the object distance, and the distance image is generated. Further, the main object region, which is the region of the main object, is extracted from the in-focus region. The correction coefficient corresponding to the object distance of the main object region is acquired from the database registered in advance.

Then, using the recovery filter generated using the acquired correction coefficient, the image recovery processing is performed on the region where the blur occurs in the main object. As described above, since the blur correction is performed on the above-described region using the recovery filter based on the correction coefficient depending on the main object region, the blur of the image caused by the image optical system can be decreased with a less amount of calculation than ever.

According to the present exemplary embodiment, the recovery processing only for the luminance is described as an example. However, the recovery processing is not limited thereto. For example, the recovery processing may be performed on an original band for each color passed through the lens, or on the plane on which a band number is converted into a different band number. Further, the image recovery processing may be preferentially performed on the in-focus region in the image compared with another region therein. In other words, the image recovery processing may be performed only on the in-focus region or the main object region.

Furthermore, the strength of the recovery filter may be changed every time the distance becomes longer centering on the in-focus region. More specifically, the image recovery processing may be performed by setting the filter strength to maximum in the in-focus region or the main object region so that the closer the pixel is located to the region, the larger the filter strength becomes (the further the pixel is located from the region, the less the filter strength becomes).

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-190442 filed Aug. 19, 2009, which is hereby incorporated by reference herein in its entirety.

What is claimed is:

1. An image processing apparatus comprising:
an input unit configured to input image data representing a captured image photographed by a photographing unit;
a region specifying unit configured to specify a region of an in-focus object in the captured image;
a filter acquisition unit configured to acquire a correction filter for correcting blur in the captured image according to information about a distance to the in-focus object; and
a correction unit configured (a) to perform blur correction processing on the captured image by applying the correction filter to the region specified by the region specifying unit, and (b) not to perform the blur correction processing performed on the region specified by the region specifying unit on a region other than the region specified by the region specifying unit.

2. The image processing apparatus according to claim 1, wherein the blur correction unit (a) performs the blur correction processing on the captured image by applying the correction filter to the region specified by the region specifying unit, and (b′) performs the blur correction processing having a correction level smaller than that of the blur correction processing performed on the region specified by the region specifying unit on the region other than the region specified by the region specifying unit.

3. The image processing apparatus according to claim 1, wherein the correction unit (a) performs the blur correction processing on the captured image by applying the correction filter to the region specified by the region specifying unit, and (b′) does not perform the blur correction processing on the region other than the region specified by the region specifying unit.

4. The image processing apparatus according to claim 1, wherein the region specifying unit specifies a main object from the region of the in-focus object in the captured image.

5. The image processing apparatus according to claim 1, wherein the region specifying unit specifies the region of the in-focus object based on a distance image.

6. The image processing apparatus according to claim 1, wherein the distance image is generated based on Coded Aperture method.

7. An image processing method comprising:
inputting image data representing a captured image photographed by a photographing unit;
specifying a region of an in-focus object in the captured image;
acquiring a correction filter for correcting blur in the captured image according to information about a distance to the in-focus object;
performing blur correction processing on the captured image by applying the correction filter to the specified region; and
not performing the blur correction processing performed on the specified region on a region other than the specified region.

8. A computer-readable storage medium storing a control program for causing a computer to execute the image processing method according to claim 7.
